(19) United States
(12) Patent Application Publication
(10) Pub. No.: US 2013/0227939 A1
(43) Pub. Date: Sep. 5, 2013

(54) HYDRAULIC SYSTEM FOR A SELF-PROPELLED WORKING MACHINE

(71) Applicant: CLAAS SELBSTFAHRENDE ERNTEMASCHINEN GMBH, Harsewinkel (DE)

(72) Inventors: Oliver Hornberg, Bielefeld (DE); Nobert Strieker, Verl (DE); Johannes Dieter Lange, Schloss Holte (DE)

(73) Assignee: CLAAS Selbstfahrende Erntemaschinen GmbH, Harsewinkel (DE)

(21) Appl. No.: 13/783,492

(22) Filed: Mar. 4, 2013

(30) Foreign Application Priority Data
Mar. 5, 2012 (DE) 102012101806.5

(51) Int. Cl. F15B 15/00

(52) U.S. Cl. CPC F15B 15/00
USPC 60/327; 60/420

(57) ABSTRACT

A hydraulic system for a self-propelled agricultural working machine includes a variable displacement pump driven by an internal combustion engine (1) and supplies a plurality of hydraulic circuits, a swept volume of which is changeable via an adjustment mechanism, and supplies pressure medium via at least one pressure line to a hydraulic motor. The hydraulic motor drives a radiator fan. An output of the radiator fan is reduced, at least temporarily, in the event of a drop in pressure for which the variable displacement pump cannot compensate.

### CROSS-REFERENCE TO A RELATED APPLICATION

The invention described and claimed hereinbelow is also described in German Patent Application DE 10 2012 101806.5, filed on Mar. 5, 2012. This German Patent Application, subject matter of which is incorporated herein by reference, provides the basis for a claim of priority of invention under 35 U.S.C. 119(a)-(d).

### BACKGROUND OF THE INVENTION

The invention relates to a hydraulic system for a self-propelled agricultural working machine that includes a variable displacement pump driven by an internal combustion engine and supplying a plurality of hydraulic circuits, a swept volume of which can be changed via an adjustment mechanism; the pump supplies pressure medium via at least one pressure line to a hydraulic motor, the hydraulic motor driving a radiator fan. The invention includes a method for operating a hydrostatically driven radiator fan of a self-propelled agricultural harvesting machine. The radiator fan is driven by a hydraulic motor disposed within a hydraulic system, and in which a variable displacement pump connected to a pressure line is provided within the hydraulic system.

Self-propelled agricultural working machines of the aforementioned type can be in the form of tractors or self-propelled harvesting machines, for example. In addition to working hydraulics, which is used to displace a rear and a front hydraulic lift, tractors typically comprise hydraulic steering. By way of the aforementioned hydraulic lifts, the attachments coupled to the tractor are raised and lowered into certain positions during individual working processes. Plowing is an example of the work performed by the tractor having an attachment, wherein the plow is raised at the headland of the field using the rear hydraulic lift assigned to the working hydraulics. Simultaneous with this lifting process, a plurality of steering motions is carried out via the steering hydraulics in order to turn the tractor.

Similarly, self-propelled agricultural harvesting machines comprise a front harvesting attachment on the front side that can be raised and lowered by way of a lifting mechanism and steering hydraulics, which usually act on the wheels of the rear axle. Hydraulic displacement of the reel also can be a component of the working hydraulics intended for raising and lowering the front harvesting attachment as long as the harvesting machine is a combine harvester and the front harvesting attachment is a header. In a related self-propelled combine harvester, at the end of the grain stand, i.e. at the headland, the front harvesting attachment is raised and then the combine harvester is turned (with the front harvesting attachment raised) by way of a plurality of steering motions in order to mow along the same stand edge, or the combine harvester is turned and driven to another stand edge.

A hydraulic system of the type mentioned is known from DE 43 36 892 A1. Therein, the variable displacement pump is in the form of a vane pump having a variable displacement volume. As such, the displacement volume of the variable displacement pump is changed by way of an eccentrically displaceable cam ring surrounding a rotor of the vane pump, upon which a hydraulically actuatable adjustment mechanism acts. The pressure medium of the variable displacement pump is thereby fed via a pressure line to a hydraulic motor, which drives a radiator fan. Furthermore, a portion of the pressure medium is directed via a flow divider to a hydraulic power-assisted steering mechanism.

DE 10 2009 052 258 A1 also makes known a hydraulic system comprising a hydraulic motor, which drives a radiator fan. Pressure medium is fed to the hydraulic motor via a variable displacement pump. A hydraulic steering mechanism is disposed in a separate hydraulic circuit in this case, in which the hydraulic steering mechanism is supplied with pressure medium via a fixed-delivery pump. An oil cooling system is disposed within this separate hydraulic circuit, which is assigned to the steering mechanism. The variable displacement pump is connected on the intake side to a pressure-medium outlet line of the hydraulic steering, whereby the two hydraulic circuits have common line sections. The radiator fan (which is driven by the hydraulic motor), is thereby driven in phases in the opposite direction of rotation in order to remove particles that have deposited in the radiator block. A 4/2-directional valve is provided for this purpose, by way of which the direction of rotation of the hydraulic motor can be reversed.

### SUMMARY OF THE INVENTION

The present invention overcomes the shortcomings of known arts, such as those mentioned above.

In an embodiment, the invention provides a hydraulic system for an agricultural working machine in which a supply of pressure medium that suffices for all operating states of the working machine is ensured by way of a variable displacement pump, the variable displacement pump configured to operate overall with a lower power loss.

In the invention, an output of the radiator fan is reduced, at least temporarily, in the event of a drop in pressure in the hydraulic system for which the variable displacement pump cannot compensate. This makes it possible to compensate for power peaks that occur in phases and cannot be covered by the basic output of the variable displacement pump. To this end, the power uptake of the radiator fan is temporarily lowered via a reduction in rotational speed up to the point at which the radiator fan comes to a standstill. The rotational speed of the radiator fan also can be reduced as a safeguard before the basic output of the variable displacement pump is exceeded.

Preferably, the hydraulic motor and the working hydraulics are both supplied with pressure medium by the variable displacement pump, where the intake volume of the hydraulic motor can be changed via an adjustment mechanism and the hydraulic system is in the form of a constant-pressure system. A pressure sensor disposed in the pressure line is connected to the adjustment mechanism. The drive of the radiator fan is therefore in the form of a hydrostatic transmission, wherein the hydraulic motor is adjustable. The variable displacement pump supplies pressure medium simultaneously to the radiator fan drive, the working hydraulics and further hydraulic consumers.

The pressure in the hydraulic system is held constant by way of relevant adjustment processes at the variable displacement pump and at the adjustable hydraulic motor of the fan drive independently of the rotational speed of the internal combustion engine driving the variable displacement pump and of the pressure medium required by the working hydraulics and the other consumers. The pressure sensor is connected directly or indirectly to the adjustment mechanisms. In the case of an indirect connection, the pressure sensor acts on one or more control mechanisms connected to the adjustment mechanism. If a brief spike in consumption by the working hydraulics occurs, the hydraulic motor is controlled to a lower intake volume during this short time period in order to hold the pressure in the hydraulic system constant.

By contrast, conventional hydraulic systems for working machines, as described in DE 43 36 892 A1 or DE 10 2009 052 258 A1, are not designed as constant-pressure systems since in these systems, only the variable displacement pump (due to the changeable displacement volume thereof), ensures a corresponding rotational speed of the radiator fan. Such corresponding rotational speed can therefore convey a changeable quantity of air through the corresponding radiator, in addition, neither of the known hydraulic systems contains working hydraulics as an additional consumer. That is, a flow divider directs the pressure medium delivered by the variable displacement pump to a first branch, which leads through the hydraulic motor of the radiator fan, and to a second branch, which leads to the steering hydraulics. The is a risk, however, that the quantities of pressure medium fed to this consumer cannot be adapted to the particular requirements. According to DE 10 2009 052 258 A1, the steering hydraulics are supplied with pressure medium by a fixed-delivery pump via a separate hydraulic circuit. This hydraulic circuit, however, communicates via common line sections with a hydraulic circuit intended for driving the radiator fan.

Preferably, the pressure line furthermore branches into a first line branch leading to the working hydraulics and into a second line branch leading to the adjustable hydraulic motor. Steering hydraulics also can be connected to the line branch supplying the working hydraulics. As mentioned above, the working hydraulics are hydraulic consumers, which are supplied only briefly with pressure medium from the pressure line. This brief supply with pressure medium takes place primarily on single-acting hydraulic cylinders, which are used to raise attachments or front attachments and to raise different loads.

Since the intake volume of the hydraulic motor driving the radiator fan is also steplessly variable, the system pressure can be held constant despite this demand for pressure medium by the working hydraulics. However, the intake volume of the hydraulic motor can briefly fall below the values specified, by way of the control, of relevant temperature sensors of the main radiator, the charge air cooler and the hydraulic fluid cooler. A corresponding reduction in the intake volume of the hydraulic motor is knowingly accepted since, as stated, the demand for pressure medium is brief.

This is advantageous in that, as compared to known solutions, the hydraulic system is able to function, due to the available means of control, with a variable displacement pump having dimensions that are smaller relative to the other requirements. The variable displacement pump displays a markedly lower power loss and therefore results in a reduction in fuel consumption by the internal combustion engine driving the working machine. A further advantage is the weight reduction that can be achieved due to the use of a variable displacement pump having smaller dimensions.

In an embodiment, at least one pressure reservoir is connected to the pressure line. A hydraulic hybrid system is therefore created, by way of which briefly occurring hydraulic power peaks can be covered. A pressure drop in the hydraulic system that can be triggered by a connecting-in of the working hydraulics (which function as the additional consumer), is initially counteracted by an increase in the volume of pressure medium delivered by the variable displacement pump. If this is insufficient, the corresponding reserves of the pressure reservoir are used, and are fed to the pressure line via a check valve. If this is insufficient, the intake volume of the hydraulic motor provided for driving the radiator fan is briefly reduced.

The hydraulic motor is preferably in the form of an axial piston unit, in which a cylinder drum, which accommodates a piston, can be swiveled relative to a control disk. Such a hydraulic pump functions according to the bent-axis principle, wherein conversion to mechanical torque takes place via the operating pressure and the displacement of the piston. The variable displacement pump is preferably designed as an axial piston unit that can be swiveled relative to a control disk. Alternatively, however, it is also possible to design both the variable displacement pump and the hydraulic motor as an adjustable vane unit. For that matter, use of other designs of variable displacement pumps may be used in the inventive systems and methods without deviating from the scope and spirit of the invention.

According to the invention, the radiator fan is assigned to radiators for the coolant of the internal combustion engine, for the charge air thereof and for the pressure medium of the hydraulic system. The radiator fan draws in outside air by way of the related radiator assembly to achieve the desired cooling effect. By way of the hydraulic system comprising a displaceable pump and an adjustable hydraulic motor, the rotational speed of the fan is regulated largely independently of the drive rotational speed of the internal combustion engine.

The adjustment mechanisms of the variable displacement pump and the hydraulic motor interacts with a control mechanism. Sensors are assigned to the control mechanism by way of which a coolant temperature, a charge-air temperature, a temperature of the pressure medium of the hydraulic system, a temperature of the surrounding air and a rotational speed of the internal combustion engine and of the radiator fan can be determined. These parameters are determined individually or in entirety, and can be used to actuate the corresponding adjustment mechanism of the adjustable hydraulic motor.

The adjustment mechanisms comprise a control mechanism that is connected to a sensor for detecting an operating state of the working hydraulics. This can be a sensor that determines the position of a directional valve used to actuate the working hydraulics. Such determinations ensures at the beginning of a displacement procedure of the working hydraulics that the pressure medium present in the pressure reservoirs is output to the pressure-medium line by way of a corresponding valve, and that an activation signal is then sent to the control of the adjustable hydraulic motor. The adjustment mechanisms of the variable displacement pump and of the hydraulic motor are actuatable by way of an electrically actuated proportional valve. Such a proportional valve comprises a precontrol valve having a proportional magnet, to which a directional valve is usually assigned.

An application of the hydraulic system in a working machine designed as a self-propelled combine harvester or forage harvester is particularly advantageous, wherein the corresponding working hydraulics function as a lifting mechanism of a front harvesting attachment. A corresponding combine harvester comprises a front harvesting attachment, for example, a header or a corn picker. If grain is harvested at a stand edge, for example, the combine harvester must be maneuvered at the headland located at the stand edge such that harvesting is subsequently carried out in the opposite direction at the same stand edge.

An appropriate lifting process and steering processes are required when harvesting is performed at several stand edges. The lifting mechanism of the front harvesting attachment is briefly actuated before the combine harvester is turned. Otherwise minor corrections of the height adjustment of the cutting mechanism may be required during the harvesting procedure, which can also be implemented by way of the lifting mechanism. The working hydraulics demand pressure medium from the variable displacement pump during these brief adjustments. As described above, a pressure drop in the hydraulic system is prevented by providing corresponding pressure reservoirs with pressure medium. But if this is insufficient, the adjustment mechanism reduces the pressure-medium uptake by the adjustable hydraulic motor.

Finally, in a method for operating a hydrostatically driven radiator fan of a self-propelled agricultural harvesting machine is provided. The radiator fan is driven by a hydraulic motor disposed within a hydraulic system and a variable displacement pump connected to a pressure line is disposed within the hydraulic system. A lifting mechanism of a front harvesting attachment (which can be actuated in phases), is disposed within the hydraulic system. The pressure in the pressure line is held constant by way of an adjustment of the swept volume of the variable displacement pump and/or an intake volume of the hydraulic motor. An intake volume of the hydraulic motor can be adjusted by way of an adjustment mechanism. The intake volume of the hydraulic motor is reduced to a minimal value during an actuation of the lifting device and a pressure drop in the pressure line associated therewith.

Using the method, the rotational speed of the radiator fan within the constant-pressure system is regulated by adjusting the intake volume of the hydraulic motor, which drives the radiator fan. If under-supply of the constant-pressure system occurs, the under-supply is compensated for via a targeted, temporary reduction of the rotational speed of the radiator fan.

As explained above, this under-supply occurs primarily at the end of a mowing and threshing procedure at the headland located at the end of the stand to be harvested. When the combine harvester is turned, additional quantities of pressure medium are briefly consumed by the lifting device of the front harvesting attachment and the steering hydraulics. If this results in a pressure drop in the constant-pressure system, this is initially compensated for by way of separate pressure reservoirs and, if this is insufficient for the compensation, the intake volume of the steplessly adjustable hydraulic motor is briefly reduced.

In the sense of predictive control, the method also makes it possible, in the event of high power demands such as lifting the front attachment, to reduce the rotational speed of the radiator fan at a point in time before the available basic output of the variable displacement pump is exceeded, i.e., before pressure drops in the constant-pressure system.

### BRIEF DESCRIPTION OF THE DRAWINGS

Further features and advantages of the invention will become apparent from the description of embodiments that follows, with reference to the attached figures, wherein:

FIG. 1 depicts a schematic illustration of a hydraulic system according to the invention, which comprises a variable displacement pump and a hydraulic motor, which is also variable.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

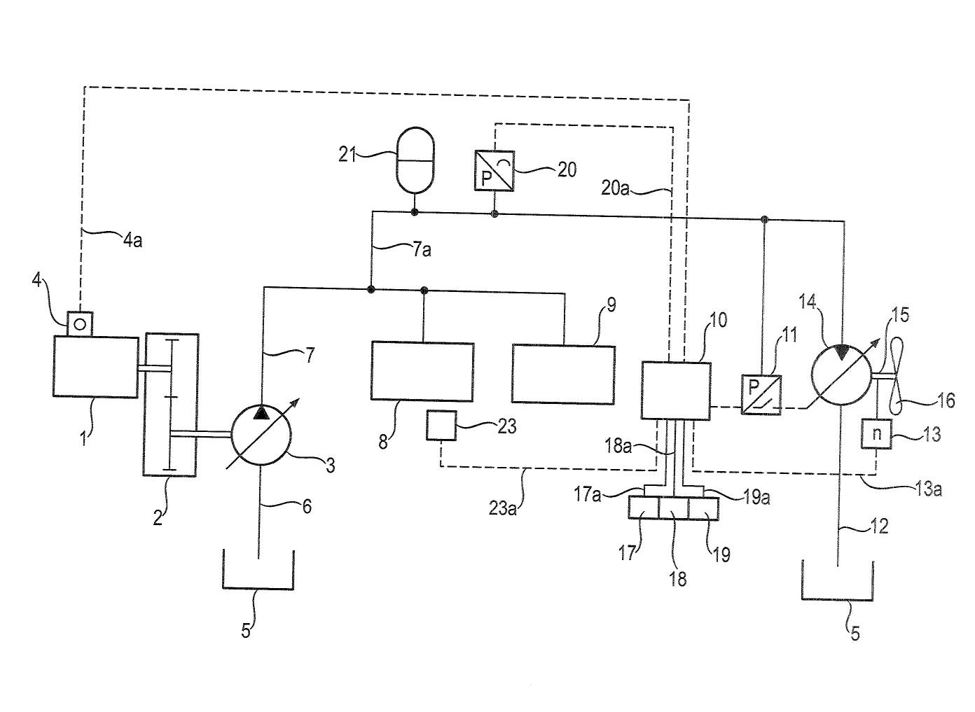

FIG. 1 shows a hydraulic system according to the invention. In the hydraulic system, an internal combustion engine 1 drives a variable displacement pump 3. To this end, a transmission 2 is disposed between the internal combustion engine 1 and the variable displacement pump 3. Alternatively, the variable displacement pump 3 can also be driven directly by the internal combustion engine 1.

The variable displacement pump 3 is preferably in the form of an axial piston pump, which operates with a variable displacement volume according to the swash plate principle. A sensor 4 for detecting rotational speed is assigned to the internal combustion engine 1, and is connected to a control mechanism 10 via a signal line 4a.

The variable displacement pump 3 is connected via an intake line 6 to an oil tank 5 and pumps pressure medium via a pressure line 7 into working hydraulics 8. The working hydraulics 8, as described above, can be in the form of a lifting mechanism for a front attachment of a harvesting machine. As shown, these working hydraulics 8 are supplied together with steering hydraulics 10 via the pressure line 7. A branch, which is labeled with 7a, of the pressure line 7, branches off from the pressure line 7 and leads to a hydraulic motor 14, the intake volume of which is variable. This hydraulic motor 14 may embody an axial piston unit according to the bent-axis principle, wherein a swash plate provided in the hydraulic motor 14 can be swiveled in order to change the intake volume.

Alternatively, a cylinder drum (which accommodates the piston of a hydraulic motor operating according to the axial piston principle), is swiveled relative to a fixed control disk.

The intake volume of the hydraulic motor 14 is changed by way of an adjustment mechanism 11 acting on the control disk thereof. As the intake volume of the hydraulic motor 14 increases (due to a greater pivot angle), the output rotational speed increases at an output shaft 15, which is connected to a radiator fan 16. The output rotational speed of the radiator fan 16 is monitored by a rotational speed sensor 13, which is connected to the control mechanism 10 via a signal line 13a. The radiator fan 16 directs a cooling air flow through non-illustrated heat exchangers for the coolant of the internal combustion engine 1 and for a charge air cooler. The pressure medium emerging from the hydraulic motor 14 reaches a return line 12, which leads into the common oil tank 5.

FIG. 1 shows that the adjustment mechanism 11 is controlled by a control mechanism 10, wherein the following are fed to the control mechanism 10: a pressure determined in the pressure line 7 by a pressure sensor 20, via a signal line 20a, and further values from a temperature sensor 17 for a temperature of a water cooler of the internal combustion engine 1, via a signal line 17a, values from a temperature sensor 18 for a temperature of the charge air, via a signal line 18a, and values from a temperature sensor 19 for a temperature of the hydraulic medium, via a signal line 19a. Depending on these parameters, the control mechanism 10 controls the adjustment mechanism 11 and, therefore, the intake volume of the hydraulic motor 14.

A pressure reservoir 21, preferably a reservoir having a gas expansion device (as shown), also is connected to the pressure line 7. Instead of this single pressure reservoir 21, a plurality of pressure reservoirs also may be connected to the pressure line 7.

In normal harvesting operation (i.e. without actuation of the working hydraulics 8), the hydraulic system is controlled such that the pressure in the pressure line 7 is constant. If the working hydraulics 8 is actuated when a headland is reached, however, this can result in a pressure drop in the pressure line 7. The rapid raising of the working hydraulics 8 is monitored by way of a suitable sensor system 23, which communicates with the control mechanism 10 via a signal line 23a. The pressure drop is initially compensated for by the pressure reservoir 21 and, if this is insufficient, by way of an additional adjustment of the hydraulic motor 14 in the direction of reduced intake volume. The sensing of a rapid raising of the working hydraulics 8 by the sensor 23 also is used to reduce the rotational speed of the radiator fan 16, as a safeguard, via the control mechanism 10 before the basic output of the variable displacement pump 3 is exceeded.

This introduction of additional pressure medium from the pressure reservoir 21 into the pressure line 7 also takes place with respect to additional consumption by the steering hydraulics 9. The hydraulic system is therefore designed with respect to the size of the variable displacement pump for normal requirements. As such, relevant consumption peaks (which can briefly occur due to one or both consumers, namely the working hydraulics 8 and the steering hydraulics 9), can be compensated for by way of a corresponding introduction from the pressure reservoir 21 and reduction of the intake quantity of the hydraulic motor 14. A reduced basic output of the utilized variable displacement pump 3 (which can be achieved as a result), not only reduces the costs for the hydraulic system but also markedly reduces the power uptake by the internal combustion engine 1. Such reduction markedly minimizes fuel consumption, thereby enabling the working machine to operate more cost effectively.

The following list of reference signs of various elements mentioned above is included (as follows), for ease of explanation:

### LIST OF REFERENCE SIGNS

1 internal combustion engine
2 transmission
3 variable displacement pump
4 engine speed sensor
4a signal line
5 oil tank
6 intake line
7 pressure line
7a branch from pressure line 7
8 working hydraulics
9 steering hydraulics
10 control mechanism
11 adjustment mechanism
12 return line
13 rotational-speed sensor
13a signal line
14 hydraulic motor
15 output shaft
16 radiator fan
17 temperature sensor
17a signal line
18 temperature sensor
18a signal line
19 temperature sensor
19a signal line
20 pressure-measuring element
21 pressure reservoir
22
23 sensor system
23a signal line

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A hydraulic system for a self-propelled agricultural working machine comprising
a variable displacement pump (3) for supplying a plurality of hydraulic circuits, a swept volume of which being changed via an adjustment mechanism (11), and for supplying pressure medium via at least one pressure line (7, 7a) to a hydraulic motor (14) for driving a radiator fan (16),
wherein an output of the radiator fan (16) is reduced, at least temporarily, in the event of a drop in pressure in the hydraulic system for which the variable displacement pump (3) cannot compensate.

2. The hydraulic system according to claim 1, wherein the variable displacement pump is driven by an internal combustion engine (1).

3. The hydraulic system according to claim 1, wherein the hydraulic motor (14) and working hydraulics (8) are both supplied with pressure medium by the variable displacement pump (3), wherein an intake volume of the hydraulic motor (14) is changed via a control mechanism (10) and wherein at least one pressure reservoir (21) is connected to the pressure line (7, 7a).

4. The hydraulic system according to claim 1, wherein the hydraulic system is a constant-pressure system.

5. The hydraulic system according to claim 1, wherein the pressure line (7) branches into a first line branch (7) leading to the working hydraulics (8) and into a second line branch (7a) leading to the adjustable hydraulic motor (14).

6. The hydraulic system according to claim 1, wherein a pressure sensor (20) disposed in the pressure line (7, 7a) is connected to the control mechanism (10).

7. The hydraulic system according to claim 1, wherein the hydraulic motor (14) comprises an axial piston unit in which a cylinder drum, which accommodates a piston, is swiveled relative to a control disk.

8. The hydraulic system according to claim 1, wherein the radiator fan (16) is assigned to radiators for the coolant of the internal combustion engine (1), the charge air and the pressure medium of the hydraulic system.

9. The hydraulic system according to claim 1, wherein the control mechanism (10) is connected to sensors (17, 18, 19, 20) for detecting any of the group consisting of: a coolant temperature, a charge air temperature, a temperature of the pressure medium of the hydraulic system, a temperature of the surrounding air, a rotational speed of the internal combustion engine (1) and any combination thereof.

10. The hydraulic system according to claim 1, wherein the control mechanism (10) is connected to a sensor (23) for detecting an operating state of the working hydraulics (8).

11. The hydraulic system according to claim 8, wherein at least the adjustment mechanism (11) is actuated by an electrically actuated proportional valve.

12. The hydraulic system according to claim 1, wherein the agricultural harvesting machine is one of a self-propelled combine harvester and a forage harvester, and wherein the working hydraulics (8) comprises a lifting device of a front attachment.

13. A method for operating a hydrostatically driven radiator fan (16) of a self-propelled agricultural harvesting machine driven by a hydraulic motor (14), disposed within a hydraulic system, and a variable displacement pump (3) connected to a pressure line (7, 7a) is disposed within the hydraulic system, the method comprising steps of:
providing a lifting mechanism of a front harvesting attachment that is actuated in phase within working hydraulics (8) of the hydraulic system;
maintaining a pressure in the pressure line (7, 7a) constant by adjusting one of a swept volume of the variable displacement pump (3) and an intake volume of the hydraulic motor (14), which can be adjusted by way of an adjustment mechanism (11), and
reducing the intake volume of the hydraulic motor (14) to a minimal value during an actuation of the working hydraulics (8), and a pressure drop in the pressure line (7, 7a) associated therewith.

14. The method of claim 13, wherein the step of maintaining includes that the intake volume is adjusted by way of an adjustment mechanism (11).

15. The method of claim 13, wherein the step of reducing includes that the working hydraulics (8) comprises a lifting device.
